(19) United States
(12) Patent Application Publication
(10) Pub. No.: US 2026/0221125 A1
(43) Pub. Date: Jul. 30, 2026

(54) CYMBAL PAD SUPPORT STRUCTURE

(71) Applicant: HOSHINO GAKKI CO., LTD., Nagoya (JP)

(72) Inventor: Hideyuki MIYAJIMA, Nagoya (JP)

(21) Appl. No.: 19/291,605

(22) Filed: Aug. 6, 2025

(30) Foreign Application Priority Data
Jan. 24, 2025 (JP) 2025-010476

(51) Int. Cl. G10D 13/10; G10H 3/14

(52) U.S. Cl. CPC G10D 13/28; G10D 13/26; G10H 3/146; G10H 3/143; G10H 2220/525

(57) ABSTRACT

A cymbal pad support structure includes a support rod, a cymbal pad, and a fixing member. The cymbal pad includes a second insertion hole. The support rod is inserted in the second insertion hole. The fixing member is fixed to a section of the support rod that protrudes upward beyond the cymbal pad. The fixing member is configured to be switchable between a fixed state in which the fixing member is attached to the support rod, so as to be immovable relative to the support rod, and an unfixed state in which the fixing member is attached to the support rod, so as to be movable relative to the support rod. The cymbal pad includes an upper surface including a protrusion. The fixing member includes a recess that is engaged with the protrusion to restrict rotation of the cymbal pad about the support rod.

### CROSS-REFERENCE TO RELATED APPLICATIONS

This application is based upon and claims the benefit of priority from Japanese Patent Application No. 2025-010476, filed on January 24, 2025, the entire contents of which are incorporated herein by reference.

### BACKGROUND

### 1. Field

The present disclosure relates to cymbal pad support structures.

### 2. Description of Related Art

Japanese Laid-Open Patent Publication No. 2003-295860 discloses a disc-shaped electronic pad that simulates a cymbal. The upper surface of the electronic pad includes a section set as a striking area that is expected to be struck. The electronic pad includes a sensor, which is placed only in the striking area to detect an impact on the electronic pad.

The electronic pad has an attachment hole through which a pole extends. A cylindrical anti-rotation member is fixed to the pole by a fastener. The upper end of the anti-rotation member is fitted into a wedge-shaped recess formed around an attachment hole in the lower surface of the electronic pad. When the anti-rotation member is fitted into the recess, the electronic pad is restricted from rotating relative to the pole. The orientation of the electronic pad is thus fixed relative to the player such that the striking area is at a predetermined position.

Also, the upper end portion of the pole extending from the electronic pad includes a threaded portion. A wing nut is attached to the threaded portion to attach the electronic pad to the pole.

To adjust the orientation of the electronic pad relative to the player, the player first removes the wing nut from the pole and operates the fastener to release the fixation between the pole and the anti-rotation member. Then, the player rotates the electronic pad together with the anti-rotation member relative to the pole in as state in which the anti-rotation member is fitted in the recess, thereby changing the orientation of the electronic pad. Finally, the player operates the fastener to fix the anti-rotation member to the pole, and attaches the wing nut to the pole.

In the electronic pad disclosed in the publication of Japanese Laid-Open Patent Publication No. 2003-295860, it is difficult for the player to visually check the anti-rotation member and the fastener from above the electronic pad. As such, to adjust the orientation of the electronic pad, the player needs to look at the electronic pad from below to operate the fastener to fix the anti-rotation member to the pole, or to release the fixation.

Alternatively, to adjust the orientation of the electronic pad, the player can remove the electronic pad from the pole and then position the recess of the electronic pad relative to the anti-rotation member such that electronic pad has a desired orientation. In this case, the player still needs to look at the electronic pad from below to operate the fastener.

For the reasons described above, the operation of adjusting the orientation of the electronic pad relative to the player is troublesome.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a cymbal pad support structure includes a support rod, a cymbal pad including an insertion hole in which the support rod is inserted, and a fixing member fixed to a section of the support rod that protrudes upward beyond the cymbal pad. The fixing member is configured to be switchable between a fixed state in which the fixing member is attached to the support rod, so as to be immovable relative to the support rod, and an unfixed state in which the fixing member is attached to the support rod, so as to be movable relative to the support rod. The cymbal pad includes an upper surface including an engaging portion. The fixing member includes an engaged portion that is engaged with the engaging portion to restrict rotation of the cymbal pad about the support rod.

Other features and aspects will be apparent from the following detailed description, the drawings, and the claims.

### BRIEF DESCRIPTION OF THE DRAWINGS

FIG. 1 is a perspective view of an electronic drum set.

FIG. 2 is an exploded perspective view of a cymbal pad support structure.

FIG. 3 is a cross-sectional view of a bracket.

FIG. 4 is an exploded perspective view of a cymbal pad.

FIG. 5 is a cross-sectional view of the cymbal pad.

FIG. 6 is a cross-sectional view taken along line 6-6 in FIG. 5.

FIG. 7 is a cross-sectional view taken along line 7-7 in FIG. 5.

FIG. 8 is a cross-sectional view of the cymbal pad taken along line 8-8 in FIG. 5.

FIG. 9 is a cross-sectional view of the cymbal pad of FIG. 8 after swinging.

FIG. 10 is a side view of the cymbal pad at a first position.

FIG. 11 is a side view of the cymbal pad at a second position.

FIG. 12 is a side view of the cymbal pad at a third position.

FIG. 13 is a side view of the cymbal pad at a fourth position.

FIG. 14 is a cross-sectional view of a cymbal pad of a modification.

FIG. 15 is a cross-sectional view of the cymbal pad of FIG. 14 in which the orientation of the fixing member is changed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

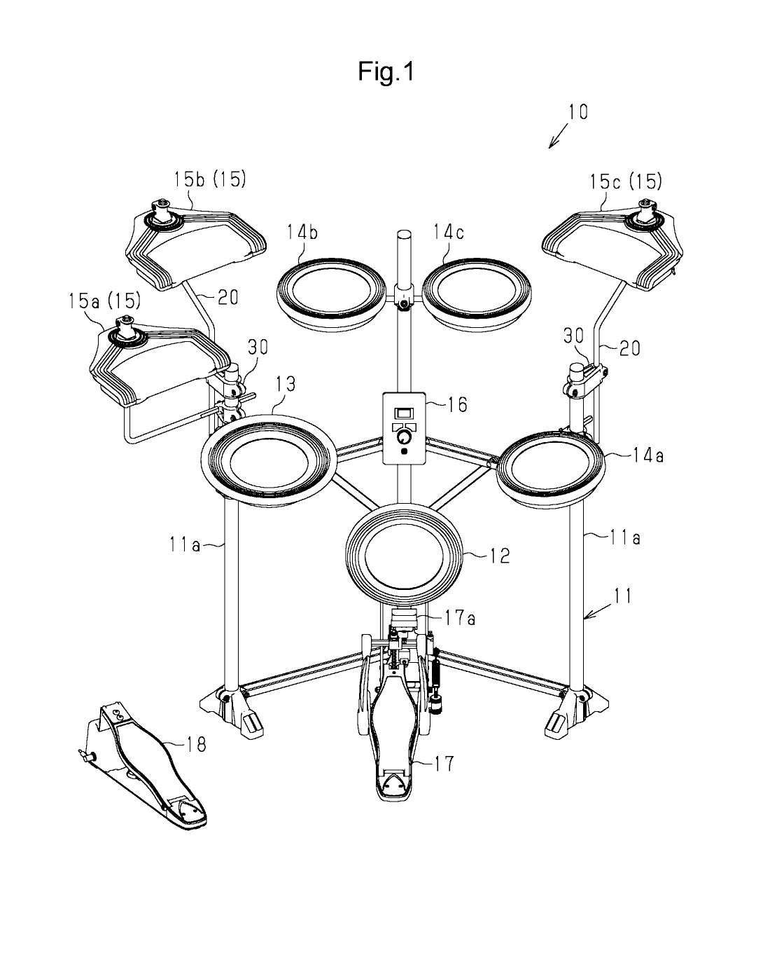

Referring to FIGS. 1 to 13, an embodiment in which a cymbal pad support structure is applied to a cymbal pad of an electronic drum set is now described.

An electronic drum set 10 includes a stand 11, a bass drum pad 12, a snare drum pad 13, a floor tom pad 14a, a first tom pad 14b, a second tom pad 14c, a hi-hat cymbal pad 15a, a first cymbal pad 15b, and a second cymbal pad 15c. The stand 11 is placed on the floor surface. The stand 11 supports the pads.

The electronic drum set 10 includes a sound source device 16, which produces sounds based on the output signals of vibration sensors provided on the pads. The sound source device 16 is attached to the stand 11. The sound source device 16 is connected to the vibration sensors of the pads by cables (not shown).

The pads other than the bass drum pad 12 are played by the player by striking them with a stick (not shown). The bass drum pad 12 is played with a pedal device 17 including a beater 17a, which swings in response to a stepping operation by the player. The hi-hat cymbal pad 15a produces a different tone when struck depending on the presence or absence of a stepping operation of a hi-hat pedal 18 by the player.

The hi-hat cymbal pad 15a, the first cymbal pad 15b, and the second cymbal pad 15c have the same configuration. In the following description, the hi-hat cymbal pad 15a, the first cymbal pad 15b, and the second cymbal pad 15c are collectively referred to as cymbal pad 15. The cymbal pad 15 is an example of an electronic cymbal pad.

### Support Structure of the Cymbal Pad 15

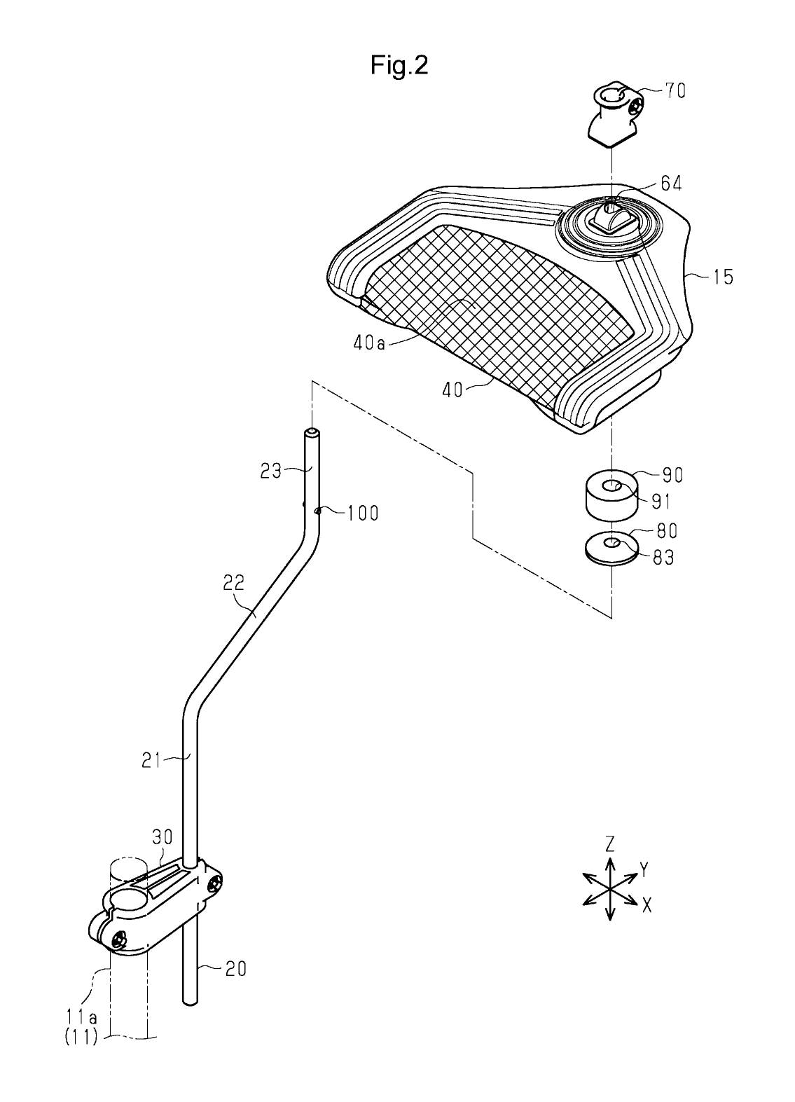

As shown in FIG. 2, the support structure for the cymbal pad 15 includes a support rod 20, a bracket 30, the cymbal pad 15, a fixing member 70, a receiving member 80, and an elastic member 90. The support rod 20 is connected to a support column 11a of the stand 11 through the bracket 30. The support rod 20 supports the cymbal pad 15. The fixing member 70, the receiving member 80, and the elastic member 90 are attached to the support rod 20.

### Configuration of the Support Rod 20

The support rod 20 includes a base portion 21, an offset portion 22, and an insertion portion 23. The base portion 21 extends linearly in the vertical direction. The offset portion 22 extends linearly from the upper end of the base portion 21 in a direction different from the length direction of the base portion 21. More specifically, the offset portion 22 extends at an angle with respect to the vertical direction so as to be higher at locations farther from the base portion 21 in the horizontal direction. The insertion portion 23 linearly extends upward from the upper end of the offset portion 22. The insertion portion 23 extends parallel to the base portion 21. The insertion portion 23 is a portion of the support rod 20 that is inserted into a second insertion hole 64 of the cymbal pad 15, which will be described below. The insertion portion 23 protrudes upward beyond the cymbal pad 15. For example, the support rod 20 may have a circular cross section.

In the following description, directions extending along the X-axis, Y-axis, and Z-axis shown in some of the drawings are referred to as the X-axis direction, the Y-axis direction, and the Z-axis direction, respectively. The X-axis direction, the Y-axis direction, and the Z-axis direction are orthogonal to each other. The Z-axis direction, the X-axis direction, and the Y-axis direction are examples of a first direction, a second direction, and a third direction, respectively. The Z-axis direction is the vertical direction and agrees with the axial direction of the insertion portion 23.

### Configuration of the Bracket 30

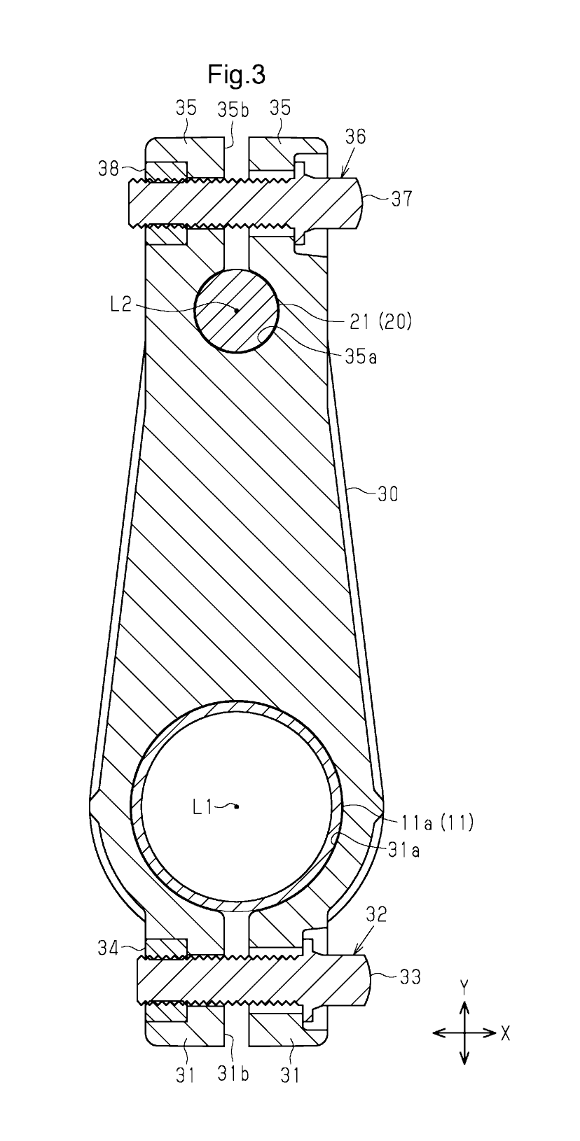

As shown in FIG. 3, the bracket 30 connects the support column 11a of the stand 11 and the base portion 21 of the support rod 20. The bracket 30 includes two first clamping portions 31, which clamp the cylindrical support column 11a, and a first tightening portion 32, which tightens the first clamping portions 31.

The first clamping portions 31 form a circular first holding hole 31a, which holds the support column 11a, and a first slit 31b continuous with the first holding hole 31a.

The first tightening portion 32 includes a first bolt 33, which extends through the first clamping portions 31, and a first nut 34, which is embedded in one of the first clamping portions 31. The first tightening portion 32 can change the amount by which the first bolt 33 is threaded into the first nut 34, thereby changing the amount by which the first clamping portions 31 are tightened on the support column 11a.

The bracket 30 includes two second clamping portions 35, which clamp the base portion 21, and a second tightening portion 36, which tightens the second clamping portions 35.

The two second clamping portions 35 form a circular second holding hole 35a, which holds the base portion 21, and a second slit 35b continuous with the second holding hole 35a. The central axis L1 of the first holding hole 31a extends along the central axis L2 of the second holding hole 35a. More specifically, the central axis L1 of the first holding hole 31a and the central axis L2 of the second holding hole 35a extend parallel to each other.

The second tightening portion 36 includes a second bolt 37, which extends through the second clamping portions 35, and a second nut 38, which is embedded in one of the second clamping portions 35. The second tightening portion 36 can change the amount by which the second bolt 37 is threaded into the second nut 38, thereby changing the amount by which the second clamping portions 35 are tightened on the base portion 21.

### Configuration of the Cymbal Pad 15

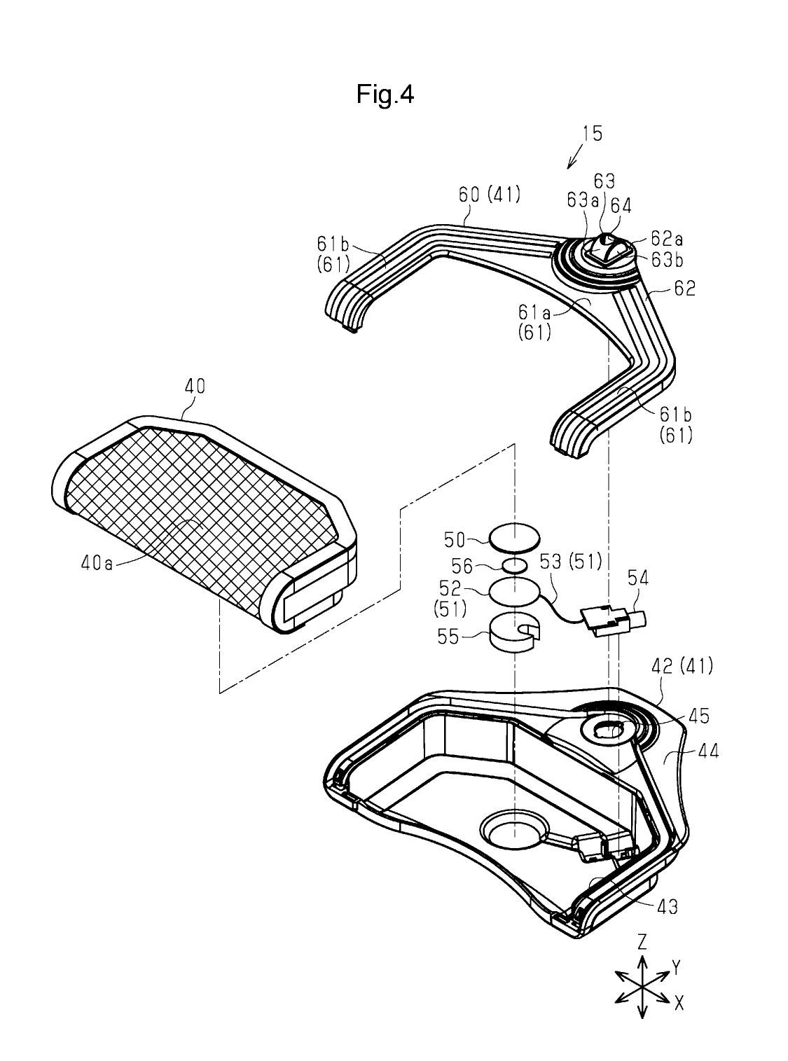

As shown in FIG. 4, the cymbal pad 15 includes an impact receiving unit 40, a case 41, a vibration plate 50, a vibration sensor 51, a first sponge 55, and a second sponge 56.

The impact receiving unit 40 includes an impact receiving surface 40a, which is to be struck by the player. The impact receiving surface 40a is provided in only a part of the cymbal pad 15 in the circumferential direction about a protrusion 63, which will be described below. More specifically, the impact receiving surface 40a is aligned with the protrusion 63 in the Y-axis direction. The impact receiving surface 40a is not aligned with the protrusion 63 in the X-axis direction.

The impact receiving unit 40 has a rectangular shape that is elongated in the X-axis direction in plan view. The impact receiving unit 40 may include a sponge and a mesh member provided on the surface of the sponge, for example. The cymbal pad 15 is placed such that the impact receiving unit 40 is opposed to the player in the Y-axis direction.

In the following description, with reference to the cymbal pad 15, a direction away from the player in the Y-axis direction is referred to as frontward, and the direction toward the player in the Y-axis direction is referred to as rearward.

The case 41 includes a case body 42, which accommodates the impact receiving unit 40, and a cover 60, which is attached to the case body 42 in a detachable manner. The cover 60 is an example of a support member. The case body 42 may be made of, for example, a hard resin material. The cover 60 may be made of an elastic material, such as a soft resin material.

The case body 42 includes an accommodating portion 43, which accommodates the impact receiving unit 40, and a case flange portion 44, which protrudes frontward from the accommodating portion 43.

The accommodating portion 43 opens upward and rearward. The case flange portion 44 protrudes frontward from the opening edge of the accommodating portion 43. The width of the case flange portion 44 in the X-axis direction decreases toward the front. The case flange portion 44 includes a first insertion hole 45, into which the insertion portion 23 of the support rod 20 is inserted.

Inside the accommodating portion 43, the impact receiving unit 40, the vibration plate 50, the second sponge 56, the vibration sensor 51, and the first sponge 55 are layered in this order from the top.

The vibration plate 50 is disc-shaped. The vibration plate 50 is in contact with the lower surface of the impact receiving unit 40.

The vibration sensor 51 detects the vibration of the cymbal pad 15. More specifically, the vibration sensor 51 detects the vibration of the vibration plate 50 when the impact receiving unit 40 is struck, and outputs a signal according to the magnitude of the vibration of the vibration plate 50 to the sound source device 16. The vibration sensor 51 includes a flat detection portion 52, which detects the vibration of the vibration plate 50, and a cable 53 connected to the detection portion 52. For example, the detection portion 52 may be a disc-shaped piezoelectric element. The distal end of the cable 53 includes a jack 54, to which a plug (not shown) extending from the sound source device 16 is connected.

The first sponge 55 is disc-shaped. The first sponge 55 presses the detection portion 52 and the vibration plate 50 toward the rear surface of the impact receiving unit 40.

The second sponge 56 is disc-shaped. The second sponge 56 is sandwiched between the vibration plate 50 and the vibration sensor 51.

The cover 60 includes a retaining portion 61, which retains the impact receiving unit 40, and a cover flange portion 62, which covers the case flange portion 44 from above.

The retaining portion 61 includes a first section 61a, which extends in the X-axis direction, and two second sections 61b extending rearward from the opposite ends of the first section 61a. The retaining portion 61 has a U-shape that opens rearward in plan view.

The cover flange portion 62 protrudes frontward from the first section 61a. The width of the cover flange portion 62 in the X-axis direction decreases toward the front.

The upper surface of the cymbal pad 15, more specifically, the upper surface of the cover flange portion 62, includes a protrusion 63. The protrusion 63 is formed integrally with the cover flange portion 62. The cross-sectional shape of the protrusion 63 orthogonal to the X-axis direction is semicircular. The protrusion 63 is an example of an "engaging portion."

The outer surface of the protrusion 63 includes a curved surface 63a and two first restricting surfaces 63b. The curved surface 63a is curved in an arc shape so as to protrude upward from one side to the other side in the Y-axis direction. The two first restricting surfaces 63b are continuous with the curved surface 63a and form opposite side surfaces of the protrusion 63 in the X-axis direction. Each of the first restricting surfaces 63b is a plane orthogonal to the X-axis direction. That is, each of the first restricting surfaces 63b is planar and extends in the Y-axis direction and the Z-axis direction. Each of the first restricting surfaces 63b has a semicircular shape as viewed from the X-axis direction. The first restricting surface 63b is an example of a restricting surface.

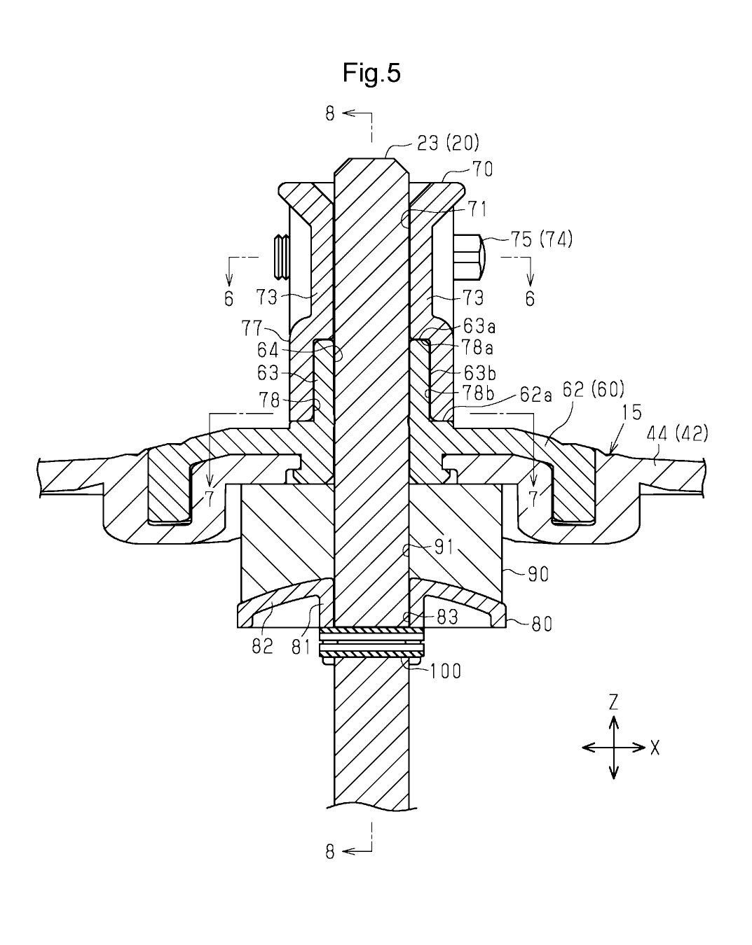

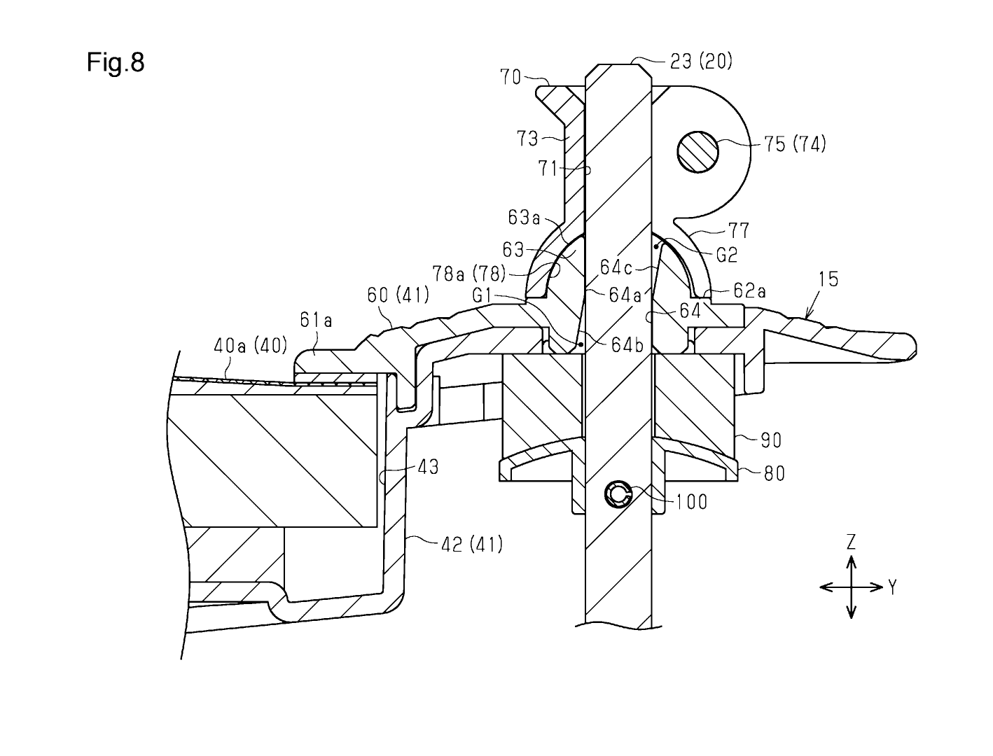

As shown in FIGS. 5 and 8, the cover flange portion 62 includes a second insertion hole 64, into which the insertion portion 23 of the support rod 20 is inserted. The second insertion hole 64 extends through the protrusion 63 and opens at the curved surface 63a. The second insertion hole 64 is an example of an insertion hole.

The insertion portion 23 inserted in the second insertion hole 64 supports the cymbal pad 15. The cymbal pad 15 extends from the insertion portion 23 in a cantilever manner. The cymbal pad 15 is rotatable about the insertion portion 23 in a state in which the insertion portion 23 is inserted in the second insertion hole 64 and the fixing member 70 is not attached to the insertion portion 23.

As shown in FIG. 8, the inner circumference surface defining the second insertion hole 64 includes a fulcrum portion 64a, a first guide portion 64b, and a second guide portion 64c. The fulcrum portion 64a is provided at the center of the second insertion hole 64 in the axial direction. The first guide portion 64b is provided below and continuous with the fulcrum portion 64a. The second guide portion 64c is provided above and continuous with the fulcrum portion 64a.

The fulcrum portion 64a is in contact with opposite sides in the Y-axis direction of the outer circumference surface of the insertion portion 23. More specifically, the fulcrum portion 64a is in contact with the outer circumference surface of the insertion portion 23 over the entire circumference. In other words, the diameter of the fulcrum portion 64a is the same as the diameter of the insertion portion.

The first guide portion 64b defines a first gap G1 between the first guide portion 64b and the insertion portion 23 on one side of the insertion portion 23 in the Y-axis direction, that is, rearward of the insertion portion 23. The first gap G1 allows the cymbal pad 15 to swing. The first gap G1 is provided on the side of the insertion portion 23 on which the impact receiving unit 40 is located. For example, the first gap G1 may have a semicircular shape as viewed from the Z-axis direction. The size of the first gap G1 decreases toward the fulcrum portion 64a. The section of the first guide portion 64b excluding the section defining the first gap G1 is entirely in contact with the outer circumference surface of the insertion portion 23.

The second guide portion 64c defines a second gap G2 between the second guide portion 64c and the insertion portion 23 on the other side of the insertion portion 23 in the Y-axis direction, that is, frontward of the insertion portion 23. The second gap G2 allows the cymbal pad 15 to swing. The second gap G2 is provided on the opposite side of the insertion portion 23 from the impact receiving unit 40. For example, the second gap G2 may have a semicircular shape as viewed from the Z-axis direction. The size of the second gap G2 decreases toward the fulcrum portion 64a. The section of the second guide portion 64c excluding the section defining the second gap G2 is entirely in contact with the outer circumference surface of the insertion portion 23.

As shown in FIGS. 5 and 8, the upper surface of the cover flange portion 62 includes a second restricting surface 62a. A restricting portion 77, which will be described below, comes into contact with the second restricting surface 62a from above. The second restricting surface 62a has the shape of a rectangular frame surrounding the outer periphery of the proximal end of the protrusion 63 (see FIG. 4). The second restricting surface 62a is located higher than the other section of the upper surface of the cover flange portion 62. The second restricting surface 62a is continuous with the curved surface 63a and the two first restricting surfaces 63b of the protrusion 63.

### Configuration of the Fixing Member 70

The fixing member 70 is fixed to the section of the insertion portion 23 that protrudes upward beyond the cymbal pad 15, that is, to the insertion portion 23.

The fixing member 70 includes a fitting hole 71, into which the insertion portion 23 is fitted. The fitting hole 71 extends through the fixing member 70 in the Z-axis direction.

As shown in FIG. 6, the fixing member 70 includes two clamping portions 73, which clamp the insertion portion 23, and a tightening portion 74, which tightens the two clamping portions 73.

The two clamping portions 73 form the fitting hole 71 and a slit 72 continuous with the fitting hole 71. The slit 72 extends over the entire extent in the Z-axis direction of the fixing member 70.

The tightening portion 74 includes a bolt 75, which extends through the clamping portions 73 in the X-axis direction, and a nut 76, which is embedded in one of the clamping portions 73. The tightening portion 74 can change the amount by which the bolt 75 is threaded into the nut 76, thereby changing the amount by which the clamping portions 73 are tightened on the insertion portion 23.

As shown in FIG. 5, the fixing member 70 includes a restricting portion 77, which is engaged with the protrusion 63. The restricting portion 77 is provided integrally with the lower sections of the two clamping portions 73. The restricting portion 77 includes a recess 78. The protrusion 63 is fitted into and engaged with the recess 78, so that the rotation of the cymbal pad 15 about the insertion portion 23 is restricted. The recess 78 opens at the lower end surface of the fixing member 70. The recess 78 is continuous with the fitting hole 71. The recess 78 is an example of an engaged portion.

As shown in FIGS. 5, 7, and 8, the inner surface defining the recess 78 is shaped to conform to the outer surface of the protrusion 63. The inner surface of the recess 78 includes a first contact surface 78a and two second contact surfaces 78b.

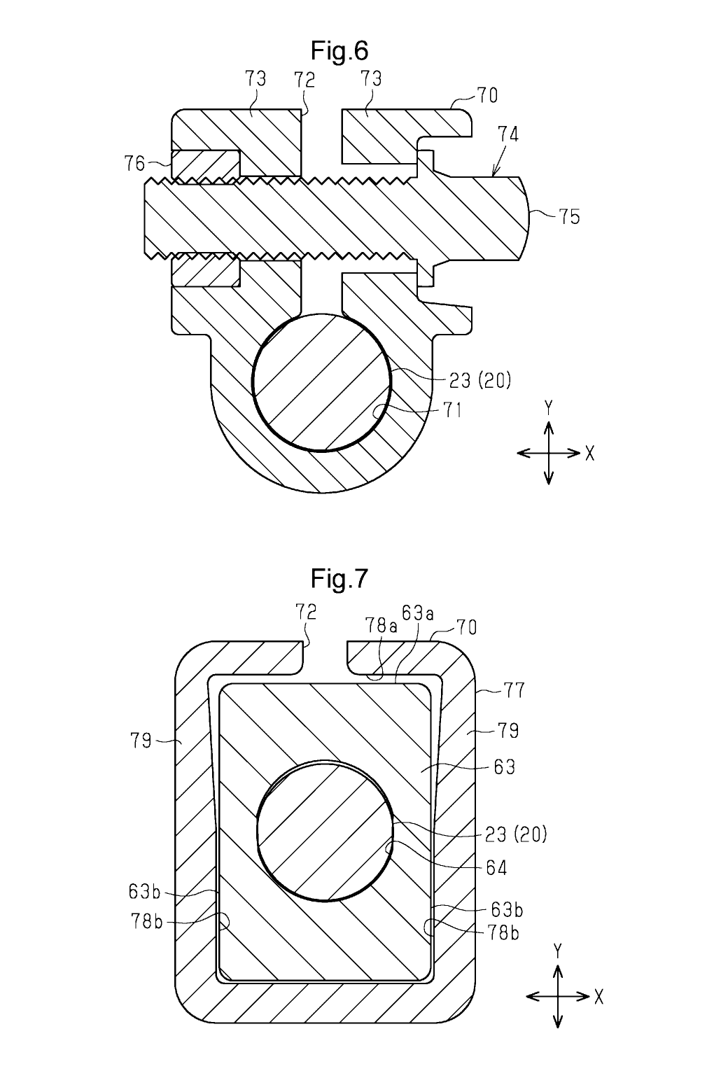

As shown in FIG. 8, the first contact surface 78a extends in a curved manner along the curved surface 63a and is in contact with the curved surface 63a. The fitting hole 71 opens at the first contact surface 78a. As shown in FIG. 7, a part of the first contact surface 78a includes a slit 72.

As shown in FIG. 5, the two second contact surfaces 78b are planar, extend along the two first restricting surfaces 63b, and are in contact with the respective first restricting surfaces 63b. The two second contact surfaces 78b are continuous with opposite side edges in the X-axis direction of the first contact surface 78a. The second contact surface 78b is an example of a contact surface.

As shown in FIG. 7, the restricting portion 77 includes two side walls 79 each forming a second contact surface 78b. The thickness of the rear end portion of each side wall 79 decreases toward the slit 72 in the Y-axis direction, that is, toward the rear. Thus, a gap is formed between each second contact surface 78b and the first restricting surface 63b before the two clamping portions 73 are tightened by the tightening portion 74. Although not shown, when the tightening portion 74 tightens the two clamping portions 73, the side walls 79 are deformed toward the first restricting surfaces 63b, bringing the entire second contact surfaces 78b into contact with the first restricting surfaces 63b. The recess 78 thus comes into contact with the protrusion 63 at opposite sides in the circumferential direction about the second insertion hole 64. As a result, the two first restricting surfaces 63b come into contact with the respective second contact surfaces 78b, thereby restricting rotation of the cymbal pad 15 about the insertion portion 23.

As shown in FIG. 5, the fixing member 70 is fixed to the insertion portion 23 when the tightening portion 74 tightens the clamping portions 73 in a state in which the insertion portion 23 is inserted in the fitting hole 71. In a state in which the protrusion 63 is engaged with the recess 78, the lower end surface of the restricting portion 77 is in contact with the second restricting surface 62a from above.

The fixing member 70 is configured to be switchable between a fixed state in which the fixing member 70 is attached so as to be immovable relative to the insertion portion 23, and an unfixed state in which the fixing member 70 is attached so as to be movable relative to the insertion portion 23, by changing the amount of tightening by the tightening portion 74. In the unfixed state, the fixing member 70 is slidable along the insertion portion 23 in the Z-axis direction. Also, in the unfixed state, the fixing member 70 is rotatable with respect to the insertion portion 23 together with the cymbal pad 15 in a state in which the protrusion 63 is fitted into the recess 78.

### Configuration of the Receiving Member 80

The receiving member 80 is attached to the insertion portion 23 at a position below the cymbal pad 15. The receiving member 80 receives the cymbal pad 15 from below. The receiving member 80 may be made of a resin material, for example.

The receiving member 80 includes a cylindrical tube portion 81 and an umbrella portion 82 extending from the upper end of the tube portion 81 toward the outer circumference. The tube portion 81 includes a first through-hole 83, through which the insertion portion 23 extends.

The receiving member 80 is supported from below by a pin 100, which extends through the insertion portion 23 in the X-axis direction. More specifically, opposite sides in the X-axis direction of the lower end of the tube portion 81 are supported from below by the end portions of the pin 100 protruding from the insertion portion 23.

The umbrella portion 82 is curved in a dome shape so as to be lower at locations farther from the tube portion 81 toward the outer circumference.

### Configuration of the Elastic Member 90

The elastic member 90 is attached to the insertion portion 23 between the receiving member 80 and the cymbal pad 15. The cymbal pad 15 presses the elastic member 90 against the receiving member 80. The elastic member 90 supports the cymbal pad 15 from below.

The elastic member 90 is cylindrical and may be made of felt, for example. The elastic member 90 includes a second through-hole 91, through which the insertion portion 23 extends. The second through-hole 91 is continuous with the second insertion hole 64 and the first through-hole 83.

### Swing State of the Cymbal Pad 15

As shown in FIG. 8, the cymbal pad 15 extends rearward from the insertion portion 23 in a cantilevered manner. Also, the second insertion hole 64 includes the first and second guide portions 64b and 64c. Thus, in a state in which the fixing member 70 is removed from the insertion portion 23, the cymbal pad 15 is movable relative to the insertion portion 23 within the range of the first gap G1 and the second gap G2. This causes the cymbal pad 15 to sag due to its own weight. However, in a state in which the fixing member 70 is fixed to the insertion portion 23, the elastic member 90 presses the second restricting surface 62a against the lower end surface of the restricting portion 77. This stops the cymbal pad 15 from sagging. As a result, the cymbal pad 15 is maintained in a horizontal position.

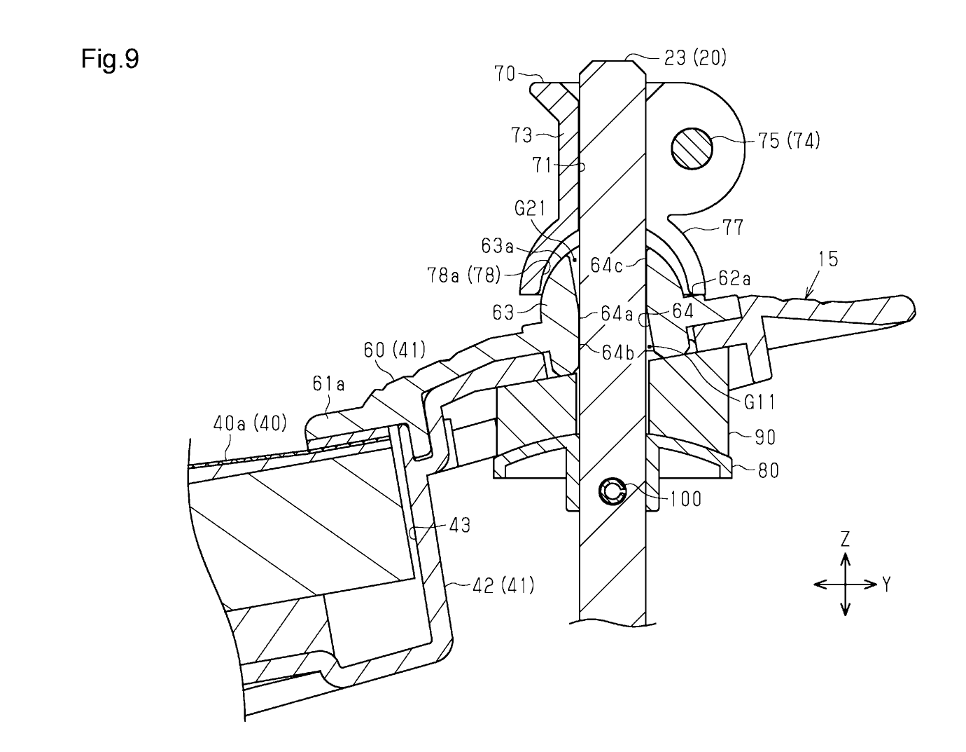

As shown in FIG. 9, when the impact receiving unit 40 is struck from above, the cymbal pad 15 tilts downward about the fulcrum portion 64a while compressing the elastic member 90 downward. As the cymbal pad 15 tilts, at the first guide portion 64b, the first gap G1 provided rearward of the insertion portion 23 is occupied, and a gap G11 is formed frontward of the insertion portion 23. At the same time, at the second guide portion 64c, the second gap G2 provided frontward of the insertion portion 23 is occupied, and a gap G21 is formed rearward of the insertion portion 23. At this time, the first guide portion 64b comes into contact with the insertion portion 23 from the rear, and the second guide portion 64c comes into contact with the insertion portion 23 from the front. This stops the downward tilting of the cymbal pad 15.

When the cymbal pad 15 tilts downward, the protrusion 63 moves such that the curved surface 63a is separated from the first contact surface 78a. The first contact surface 78a functions to facilitate the separation of the curved surface 63a of the moving protrusion 63. Also, when the cymbal pad 15 tilts downward, the two second contact surfaces 78b slide on the two first restricting surfaces 63b in a planar direction orthogonal to the X-axis direction.

The cymbal pad 15 that has tilted downward returns to its pre-strike position due to the restoring force of the elastic member 90. In this manner, when the cymbal pad 15 is struck, the cymbal pad 15 swings.

### Position Adjustment of the Cymbal Pad 15

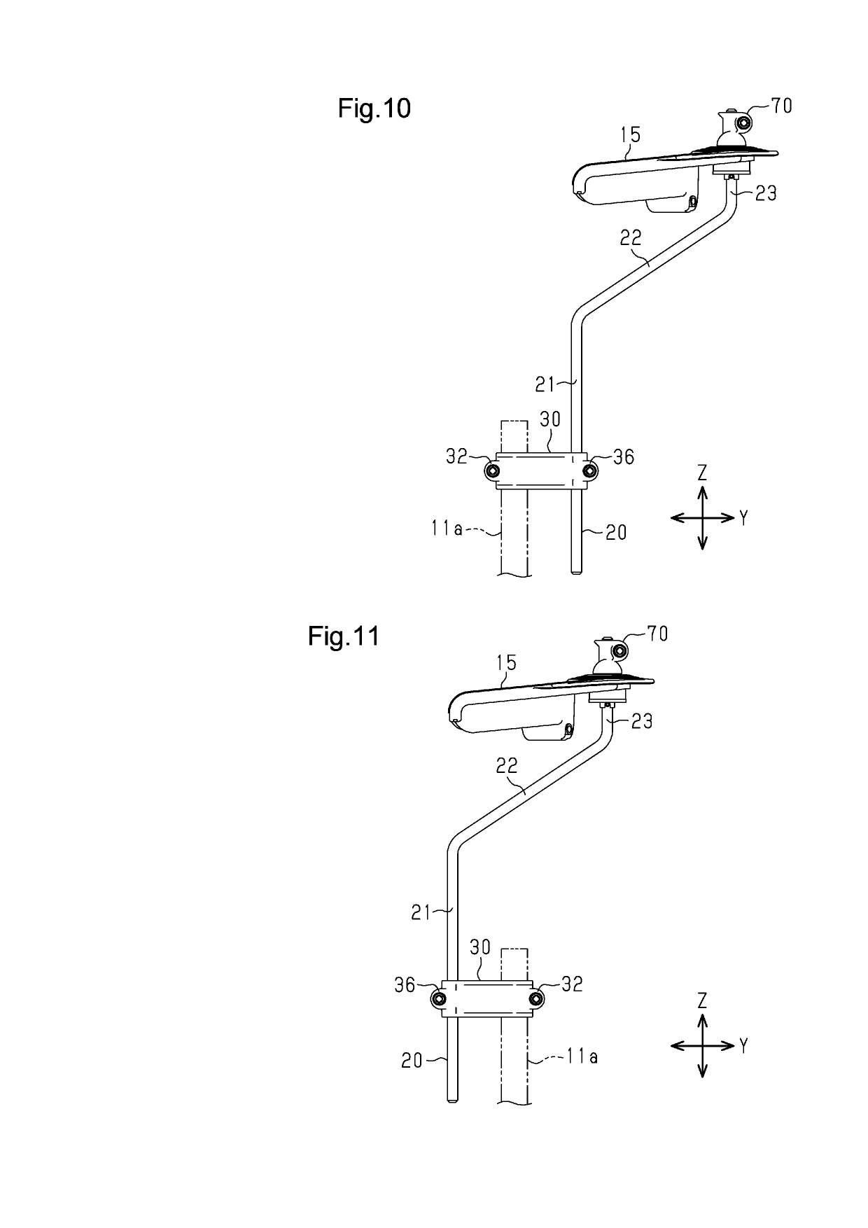

As shown in FIG. 10, the cymbal pad 15 is connected to the support column 11a through the bracket 30 and the support rod 20. Loosening the first tightening portion 32 of the bracket 30 allows the bracket 30 to rotate relative to the support column 11a over the entire circumference. Also, loosening the second tightening portion 36 of the bracket 30 allows the support rod 20 to rotate relative to the bracket 30 over the entire circumference. Furthermore, placing the fixing member 70 in the unfixed state allows the cymbal pad 15 to rotate relative to the support rod 20 over the entire circumference. As such, by rotating at least one of the bracket 30, the support rod 20, and the cymbal pad 15, the position of the cymbal pad 15 relative to the support column 11a can be changed to a desired position.

As examples of positions at which the cymbal pad 15 can be placed, first to fourth positions shown in FIGS. 10 to 13 are now described. When the cymbal pad 15 is located at the first position, the second position, the third position, or the fourth position, the impact receiving unit 40 of the cymbal pad 15 is opposed to the player in the Y-axis direction. The player can change the distance between the cymbal pad 15 and the player in the Y-axis direction in a stepwise manner by changing the position of the cymbal pad 15 between the first position, the second position, the third position, and the fourth position.

As shown in FIG. 10, the first position is a position at which the cymbal pad 15 is located on the front side and is farthest from the support column 11a. When the cymbal pad 15 is located at the first position, both the base portion 21 and the insertion portion 23 are located frontward of the support column 11a. At this time, the second tightening portion 36 is located frontward of the support column 11a.

As shown in FIG. 11, the second position is a position at which the cymbal pad 15 is located rearward of the first position. When the cymbal pad 15 is located at the second position, the base portion 21 is located rearward of the support column 11a and the insertion portion 23 is located frontward of the support column 11a.

In a state in which the cymbal pad 15 is at the first position, the cymbal pad 15 can be moved to the second position by rotating the bracket 30 and the support rod 20. More specifically, first, in a state in which the cymbal pad 15 is located at the first position, the bracket 30 is rotated relative to the support column 11a so as to place the second tightening portion 36 rearward of the support column 11a. Then, the support rod 20 is rotated relative to the bracket 30 so as to place the insertion portion 23 frontward of the support column 11a, thereby moving the cymbal pad 15 to the second position.

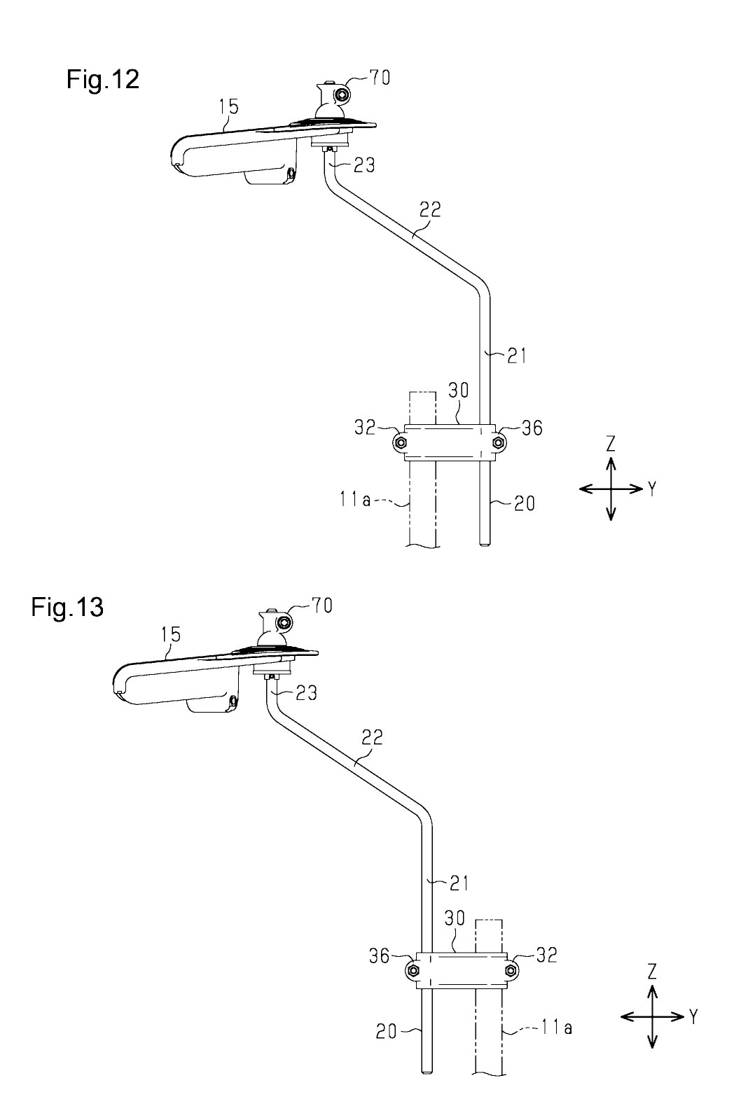

As shown in FIG. 12, the third position is a position at which the cymbal pad 15 is located rearward of the second position. When the cymbal pad 15 is located at the third position, the base portion 21 is located frontward of the support column 11a and the insertion portion 23 is located rearward of the support column 11a.

In a state in which the cymbal pad 15 is at the first position, the cymbal pad 15 can be moved to the third position by rotating the support rod 20 and also rotating the cymbal pad 15. More specifically, first, the support rod 20 is rotated relative to the bracket 30 so as to place the insertion portion 23 rearward of the support column 11a. Then, the cymbal pad 15 is rotated relative to the support rod 20 so as to place the impact receiving unit 40 rearward of the insertion portion 23, thereby moving the cymbal pad 15 to the third position.

As shown in FIG. 13, the fourth position is a position at which the cymbal pad 15 is located rearward of the third position, and is a position at which the cymbal pad 15 is located on the rear side and is farthest from the support column 11a. When the cymbal pad 15 is at the fourth position, both the base portion 21 and the insertion portion 23 are located rearward of the support column 11a.

In a state in which the cymbal pad 15 is at the first position, the cymbal pad 15 can be moved to the fourth position by rotating the bracket 30 and also rotating the cymbal pad 15. More specifically, first, in a state in which the cymbal pad 15 is located at the first position, the bracket 30 is rotated relative to the support column 11a so as to place the second tightening portion 36 rearward of the support column 11a. Then, the cymbal pad 15 is rotated relative to the support rod 20 so as to place the impact receiving unit 40 rearward of the insertion portion 23, thereby moving the cymbal pad 15 to the fourth position.

Loosening the first tightening portion 32 allows the height position of the bracket 30 to be changed relative to the support column 11a. Also, loosening the second tightening portion 36 allows the height position of the support rod 20 to be changed relative to the bracket 30. As such, the height position of the cymbal pad 15 can also be freely changed.

### Operation of the Present Embodiment

According to the cymbal pad 15 of the present embodiment, the protrusion 63 is engaged with the recess 78 of the fixing member 70 in the fixed state, thereby restricting the rotation of the cymbal pad 15 about the support rod 20.

To adjust the orientation of the cymbal pad 15 relative to the player, the player first loosens the tightening portion 74 to switch the fixing member 70 from the fixed state to the unfixed state. This allows the fixing member 70 to move relative to the support rod 20. Then, the player rotates the fixing member 70 together with the cymbal pad 15 relative to the support rod 20 while maintaining the engagement between the protrusion 63 and the recess 78, thereby changing the orientation of the cymbal pad 15 to a desired orientation. Finally, the player tightens the two clamping portions 73 with the tightening portions 74, switching the fixing member 70 from the unfixed state to the fixed state.

### Advantages of the Present Embodiment

(1) The fixing member 70 is fixed to the insertion portion 23 of the support rod 20. The fixing member 70 is configured to be switchable between a fixed state in which the fixing member is attached so as to be immovable relative to the support rod 20 and an unfixed state in which the fixing member 70 is attached so as to be movable relative to the support rod 20. The upper surface of the cymbal pad 15 includes the protrusion 63. The fixing member 70 includes the recess 78, which is engaged with the protrusion 63 so that the rotation of the cymbal pad 15 about the support rod 20 is restricted.

According to the above configuration, the fixing member 70 is fixed to the insertion portion 23 of the support rod 20. Thus, when adjusting the orientation of the cymbal pad 15, the player can switch the fixing member 70 between the fixed state and the unfixed state while checking the fixing member 70 from above the cymbal pad 15. This allows the player to operate the fixing member 70 without having to significantly change his/her posture, for example to look at the cymbal pad 15 from below. This facilitates the operation of adjusting the orientation of the cymbal pad 15 relative to the player.

Furthermore, according to the above configuration, the protrusion 63 is fitted into the recess 78, so that the protrusion 63 and the recess 78 are engaged with each other. This allows the player to readily check from above the cymbal pad 15 whether the protrusion 63 is fitted into the recess 78.

Also, if the cymbal pad 15 includes a recess 78 and the fixing member 70 includes a protrusion 63, for example, the cymbal pad 15 needs to be thick enough to include a recess 78. This may limit the shape of the cymbal pad 15.

In this respect, according to the above configuration, the degree of freedom in the shape of the cymbal pad 15 is higher than that in a configuration in which the cymbal pad 15 includes a recess 78 and the fixing member 70 includes a protrusion 63.

(2) The second insertion hole 64 extends through the protrusion 63. The outer surface of the protrusion 63 includes the first restricting surfaces 63b. The inner surface of the recess 78 includes the second contact surfaces 78b, which extend along the first restricting surfaces 63b and are in contact with the first restricting surfaces 63b.

According to the above configuration, since the second insertion hole 64 extends through the protrusion 63, the protrusion 63 and the insertion portion 23 of the support rod 20 are coaxial. As such, attaching the fixing member 70 to the insertion portion 23 causes the protrusion 63 to be fitted into the recess 78. This brings the first restricting surfaces 63b into contact with the second contact surfaces 78b, thereby restricting the rotation of the cymbal pad 15. As such, the operation of attaching the fixing member 70 to the support rod 20 and the operation of engaging the protrusion 63 with the recess 78 can be performed simultaneously or in succession. The cymbal pad 15 is thus smoothly fixed to the support rod 20.

(3) The cymbal pad 15 includes the case body 42 and the cover 60. The case body 42 accommodates the impact receiving unit 40. The cover 60 is made of an elastic material. The cover 60 forms the protrusion 63 and is attached to the case body 42.

According to the above configuration, the cover 60 attached to the case body 42 forms the protrusion 63, so that the support rod 20 inserted in the second insertion hole 64 of the protrusion 63 extends through the cover 60. For this reason, the cover 60 made of an elastic material is interposed between the case body 42 and the support rod 20, and between the case body 42 and the fixing member 70. This limits generation of contact noise between the cymbal pad 15 and the support rod 20 and between the cymbal pad 15 and the fixing member 70 when the cymbal pad 15 is struck.

Also, according to the above configuration, the vibration caused by striking the impact receiving unit 40 is less likely to be transmitted to the other pads of the electronic drum set 10. Accordingly, the vibration sensors of these pads do not react to the vibration. Furthermore, even if the vibration caused by striking the other pads is transmitted to the support rod 20, the cover 60 absorbs this vibration, so that the vibration is less likely to be transmitted to the vibration sensor 51 of the cymbal pad 15.

(4) The opposite side portions in the X-axis direction of the outer surface of the protrusion 63 are formed by the planar first restricting surfaces 63b extending in the Y-axis direction. As viewed from the Z-axis direction, the impact receiving surface 40a is aligned with the protrusion 63 in the Y-axis direction. The first gap G1 and the second gap G2, which allow the cymbal pad 15 to swing, are provided between the outer circumference surface of the support rod 20 and the inner circumference surface defining the second insertion hole 64.

According to the above configuration, the first gap G1 and the second gap G2, which allow the cymbal pad 15 to swing, are provided between the outer circumference surface of the support rod 20 and the inner circumference surface defining the second insertion hole 64. The opposite side portions in the X-axis direction of the outer surface of the protrusion 63 are formed by the first restricting surfaces 63b. Since the first restricting surfaces 63b are in contact with the second contact surfaces 78b of the fixing member 70 in the X-axis direction, the end portions of the cymbal pad 15 in the X-axis direction are restricted from swinging up and down. In contrast, since the first restricting surfaces 63b are planar and extend in the Y-axis direction, the first restricting surfaces 63b can slide on the second contact surfaces 78b, allowing the end portions of the cymbal pad 15 in the Y-axis direction to swing up and down. This allows the player to play the cymbal pad 15 while causing it to swing up and down by striking the impact receiving surface 40a, which is aligned with the protrusion 63 in the Y-axis direction as viewed from the Z-axis direction.

(5) The fulcrum portion 64a is in contact with opposite side portions in the Y-axis direction of the outer circumference surface of the support rod 20. The first guide portion 64b defines the first gap G1, which allows the cymbal pad 15 to swing, between the first guide portion 64b and the support rod 20 on the rear side of the support rod 20. The second guide portion 64c defines the second gap G2, which allows the cymbal pad 15 to swing, between the second guide portion 64c and the support rod 20 on the front side of the support rod 20. The section of the first guide portion 64b, excluding the section defining the first gap G1, and the section of the second guide portion 64c, excluding the section defining the second gap G2, are in contact with the outer circumference surface of the support rod 20.

According to the above configuration, the first guide portion 64b, provided below the fulcrum portion 64a, defines the first gap G1 between the first guide portion 64b and the support rod 20. The second guide portion 64c, provided above the fulcrum portion 64a, defines the second gap G2 between the second guide portion 64c and the support rod 20. Thus, when the player strikes the impact receiving surface 40a of the cymbal pad 15 from above, the cymbal pad 15 tilts about the fulcrum portion 64a. This tilting causes the first guide portion 64b to move from the rear to the front so as to occupy the first gap G1 and come into contact with the support rod 20. At the same time, the second guide portion 64c moves from the front to the rear so as to occupy the second gap G2 and come into contact with the support rod 20. Before the impact receiving surface 40a is struck, the section of the first guide portion 64b, excluding the section defining the first gap G1, and the section of the second guide portion 64c, excluding the section defining the second gap G2, are in contact with the outer circumference surface of the support rod 20. As such, in addition to the first restricting surfaces 63b and the second contact surfaces 78b, the first and second guide portions 64b and 64c guide the swinging of the cymbal pad 15 such that one end portion in the Y-axis direction of the cymbal pad 15 swings up and down. This allows the cymbal pad 15 to swing more stably.

(6) The elastic member 90 supports the cymbal pad 15 from below.

According to the above configuration, the cymbal pad 15 is supported from below by the elastic member 90. This achieves the positioning of the cymbal pad 15 in the length direction of the support rod 20. Furthermore, when the cymbal pad 15 is struck, the elastic member 90 is elastically deformed, allowing the cymbal pad 15 to swing. This enables the player to play the cymbal pad 15 while causing the cymbal pad 15 to swing.

(7) The fixing member 70 is configured such that the fixing position of the fixing member 70 in the length direction of the support rod 20 is changeable.

According to the above configuration, by changing the fixing position of the fixing member 70 in the length direction of the support rod 20, the degree of pressing of the cymbal pad 15 against the elastic member 90 can be adjusted. This allows the degree of swinging of the cymbal pad 15 to be adjusted.

(8) The fixing member 70 includes two clamping portions 73, which clamp the support rod 20, and the tightening portion 74, which tightens the two clamping portions 73.

For example, if the fixing member 70 is configured to be fixed to the support rod 20 by the meshing between an external thread formed in the support rod 20 and an internal thread formed in the fixing member 70, any force acting on the cymbal pad 15 in the circumferential direction of the second insertion hole 64 while the cymbal pad 15 is played may loosen the meshing between the internal and external threads. In this case, the orientation of the cymbal pad 15 relative to the player may change while the cymbal pad 15 is being played.

In this respect, according to the above configuration, the fixing member 70 is attached so as to be immovable relative to the support rod 20 by tightening with the tightening portion 74 the two clamping portions 73 clamping the support rod 20. This limits a decrease in the tightening force of the tightening portion 74 even when a force acts on the cymbal pad 15 in the circumferential direction of the second insertion hole 64. As a result, the orientation of the cymbal pad 15 relative to the player is less likely to change while the cymbal pad 15 is being played.

(9) The support rod 20 includes the base portion 21, which extends in the vertical direction, the offset portion 22, which extends from the base portion 21 in a direction different from the length direction of the base portion 21, and the insertion portion 23, which extends upward from the offset portion 22. The bracket 30 includes two first clamping portions 31, which clamp the support column 11a, the first tightening portion 32, which tightens the two first clamping portions 31, two second clamping portions 35, which clamp the base portion 21, and the second tightening portion 36, which tightens the two second clamping portions 35. The two first clamping portions 31 form the first holding hole 31a for holding the support column 11a. The two second clamping portions 35 form the second holding hole 35a for holding the base portion 21. The central axis L1 of the first holding hole 31a extends along the central axis L2 of the second holding hole 35a.

According to the above configuration, the central axis L1 of the first holding hole 31a of the first clamping portions 31 extends along the central axis L2 of the second holding hole 35a of the second clamping portions 35. This allows the bracket 30 to connect the support column 11a and the support rod 20, which extends along the support column 11a.

Also, the position of the bracket 30 relative to the support column 11a can be changed by loosening the tightening of the two first clamping portions 31 by the first tightening portion 32 and rotating the bracket 30. Furthermore, the position of the support rod 20 relative to the bracket 30 can be changed by loosening the tightening of the two second clamping portions 35 by the second tightening portion 36 and rotating the support rod 20. Since the support rod 20 includes the offset portion 22, the position of the insertion portion 23 relative to the support column 11a, that is, the position of the cymbal pad 15 relative to the support column 11a is changeable by rotating the support rod 20 relative to the bracket 30. In this manner, the degree of freedom in adjusting the position of the cymbal pad 15 relative to the support column 11a can be increased by combining the rotation of the bracket 30 relative to the support column 11a and the rotation of the support rod 20 relative to the bracket 30. As a result, the distance between the player and the cymbal pad 15 can be suitably adjusted.

### Modifications

The present embodiment may be modified and implemented as follows. The embodiment and the following modifications may be combined to an extent that does not cause technical contradiction.

The impact receiving unit 40 may include an elastic material, such as rubber, instead of sponge.

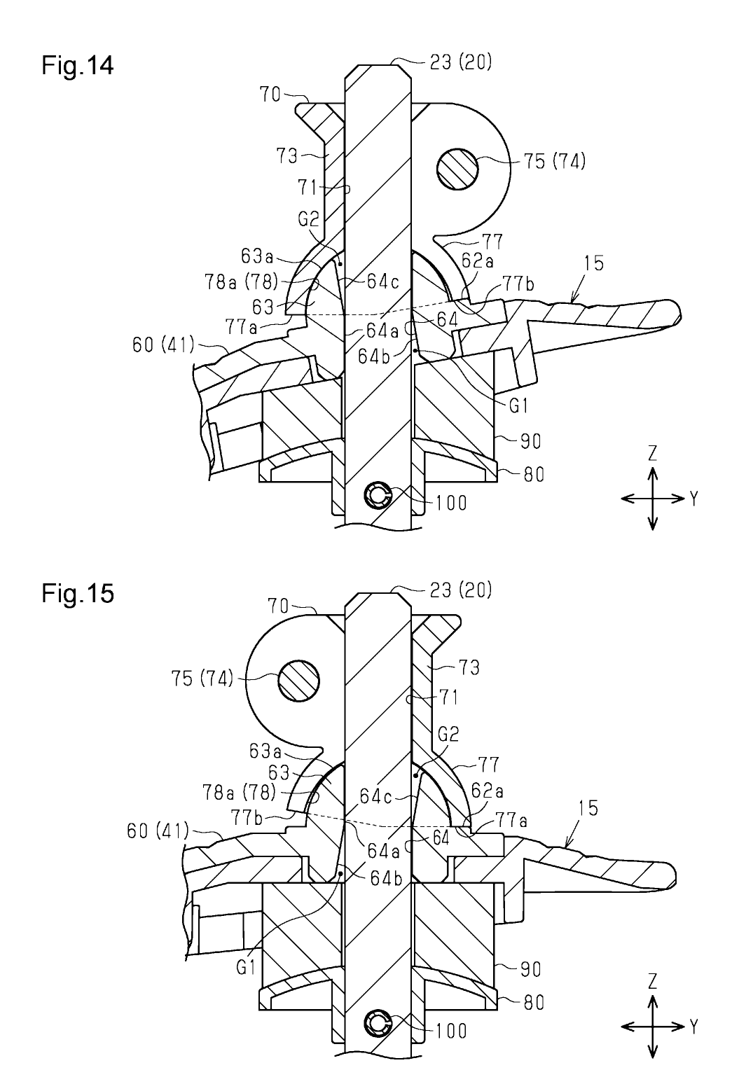

As shown in FIG. 14, the lower end surface of the restricting portion 77 may include a flat surface 77a orthogonal to the Z-axis direction and an inclined surface 77b inclined with respect to the flat surface 77a. The flat surface 77a and the inclined surface 77b form the sections of the lower end surface of the restricting portion 77 located on one side and the other side, respectively, in the Y-axis direction of the center of the arc of the curved surface 63a. The inclined surface 77b is inclined with respect to the flat surface 77a so as to be closer to the clamping portions 73 in the Z-axis direction at locations farther from the flat surface 77a in the Y-axis direction. When the fixing member 70 is fixed to the support rod 20 such that the inclined surface 77b is positioned frontward of the flat surface 77a, the orientation of the cymbal pad 15 is maintained in a state in which the second restricting surface 62a is in contact with the inclined surface 77b, that is, in a state in which the cymbal pad 15 sags due to its own weight. At this time, the second restricting surface 62a is not in contact with the flat surface 77a. When the cymbal pad 15 is struck in this state, the curved surface 63a and the first contact surface 78a slide against each other in a state in which the center of the arc of the curved surface 63a coincides with the center of the arc of the first contact surface 78a. This allows the cymbal pad 15 to swing smoothly. Alternatively, as shown in FIG. 15, the fixing member 70 may be fixed to the support rod 20 such that the inclined surface 77b is positioned rearward of the flat surface 77a. In this case, the second restricting surface 62a is in contact with the flat surface 77a, maintaining the cymbal pad 15 in a horizontal position. As such, the cymbal pad 15 can swing in the same manner as in the above embodiment.

In the present embodiment, an example has been described in which the cymbal pad support structure is applied to a cymbal pad 15 that forms an electronic drum set 10, but the cymbal pad support structure can also be applied to a cymbal pad for practice that does not include a vibration sensor 51.

The offset portion 22 may extend linearly from the base portion 21 in a direction orthogonal to the base portion 21.

The offset portion 22 does not need to extend linearly. The offset portion 22 may be bent at multiple positions.

Instead of the support rod 20, the support column 11a may be inserted into the second insertion hole 64. In this case, the cymbal pad 15 is supported by the stand 11 by fixing the fixing member 70 to the support column 11a. In this modification, the support column 11a corresponds to a "support rod."

The central axis L1 of the first holding hole 31a and the central axis L2 of the second holding hole 35a do not need to extend strictly parallel to each other. The central axes L1 and L2 may extend substantially parallel to each other as long as the advantages of the present embodiment are achieved.

The tightening portion 74 does not necessarily need to include the nut 76. The tightening portion 74 may be formed by a bolt 75 inserted into one of the two clamping portions 73 and an internal thread formed in the other of the two clamping portions 73. This modification is also applicable to the first and second tightening portions 32 and 36 of the bracket 30 in a similar manner.

The fixing member 70 does not need to be configured such that the fixing position relative to the support rod 20 is changeable. The fixing member 70 may be engaged with the support rod 20 and attached so as not to move relative to the support rod 20 at a predetermined position.

The elastic member 90 may be made of an elastic material other than felt, such as rubber.

The receiving member 80 may be made of an elastic material such as rubber. In this case, the elastic member 90 may be omitted, and the cymbal pad 15 may be supported directly from below by the receiving member 80. In this configuration, since the receiving member 80 corresponds to an "elastic member", an advantage equivalent to advantage (6) can be achieved.

The second insertion hole 64 does not necessarily need to include the first guide portion 64b and the second guide portion 64c. In this case, the cymbal pad 15 can still swing by elastic deformation of the elastic member 90 and the protrusion 63.

The protrusion 63 may be formed separately from the cover flange portion 62.

The first restricting surfaces 63b may be inclined with respect to the Z-axis direction. For example, the two first restricting surfaces 63b may be inclined with respect to the Z-axis direction so as to be closer to each other in the X-axis direction as they extend upward.

The outer surface of the protrusion 63 may include a single first restricting surface 63b.

The outer surface of the protrusion 63 does not necessarily need to include the curved surface 63a. In this case, the first contact surface 78a does not need to be curved.

The protrusion 63 does not necessarily need to include the second insertion hole 64. For example, multiple protrusions 63 may be provided around a second insertion hole 64 formed in the upper surface of the cover flange portion 62. In this case, the fixing member 70 preferably includes multiple recesses 78 into which the protrusions 63 are fitted. This configuration still restricts the rotation of the cymbal pad 15 about the support rod 20 by the engagement between the protrusions 63 and the recesses 78.

The cymbal pad 15 may include a recess 78, and the fixing member 70 may include a protrusion 63.

A projection extending from the upper surface of the cover flange portion 62 may be engaged with the outer circumference surface of the fixing member 70 in the circumferential direction of the second insertion hole 64. With this configuration, since the rotation of the cymbal pad 15 is restricted, the player can still engage the cymbal pad 15 with the fixing member 70 while visually checking the engagement operation.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A cymbal pad support structure, comprising:
a support rod;
a cymbal pad including an insertion hole in which the support rod is inserted; and
a fixing member fixed to a section of the support rod that protrudes upward beyond the cymbal pad, wherein
the fixing member is configured to be switchable between a fixed state in which the fixing member is attached to the support rod, so as to be immovable relative to the support rod, and an unfixed state in which the fixing member is attached to the support rod, so as to be movable relative to the support rod,
the cymbal pad includes an upper surface including an engaging portion, and
the fixing member includes an engaged portion that is engaged with the engaging portion to restrict rotation of the cymbal pad about the support rod.

2. The cymbal pad support structure according to claim 1, wherein
one of the engaging portion and the engaged portion is a protrusion, and
the other of the engaging portion and the engaged portion is a recess for fitting with the protrusion.

3. The cymbal pad support structure according to claim 2, wherein
the engaging portion is the protrusion, and
the engaged portion is the recess.

4. The cymbal pad support structure according to claim 3, wherein
the insertion hole extends through the protrusion,
the protrusion includes an outer surface including a restricting surface, and
the recess includes an inner surface including a contact surface that extends along the restricting surface and contacts the restricting surface.

5. The cymbal pad support structure according to claim 4, wherein
the cymbal pad includes:
a case body that accommodates an impact receiving unit; and
a support member that is made of an elastic material, forms the protrusion, and is attached to the case body.

6. The cymbal pad support structure according to claim 4, wherein
an axial direction of a section of the support rod that is inserted in the insertion hole is a first direction,
a direction orthogonal to the first direction is a second direction,
a direction orthogonal to both the first and second directions is a third direction,
the cymbal pad includes an impact receiving surface,
at least a section of the outer surface of the protrusion that is located on one side in the second direction is formed by the restricting surface that is planar and extends in the third direction,
the impact receiving surface is aligned with the protrusion in the third direction as viewed from the first direction, and
a gap is defined between an outer circumference surface of the support rod and an inner circumference surface defining the insertion hole to allow the cymbal pad to swing.

7. The cymbal pad support structure according to claim 6, wherein
the inner circumference surface defining the insertion hole includes:
a fulcrum portion that is in contact with opposite side portions in the third direction of the outer circumference surface of the support rod;
a first guide portion provided below the fulcrum portion; and
a second guide portion provided above the fulcrum portion,
the first guide portion defines a first gap between the first guide portion and the support rod on one side in the third direction of the support rod to allow the cymbal pad to swing,
the second guide portion defines a second gap between the second guide portion and the support rod on the other side in the third direction of the support rod to allow the cymbal pad to swing, and
a section of the first guide portion, excluding a section defining the first gap, and a section of the second guide portion, excluding a section defining the second gap, are in contact with the outer circumference surface of the support rod.

8. The cymbal pad support structure according to claim 1, further comprising an elastic member attached to the support rod to support the cymbal pad from below.

9. The cymbal pad support structure according to claim 8, wherein the fixing member is configured such that a fixing position in a length direction of the support rod is changeable.

10. The cymbal pad support structure according to claim 1, wherein the fixing member includes two clamping portions that clamp the support rod and a tightening portion that tightens the two clamping portions.

11. The cymbal pad support structure according to claim 1, further comprising
a bracket configured to connect the support rod to a support column of a stand installed on a floor surface, wherein
the support rod includes:
a base portion extending in a vertical direction;
an offset portion extending from the base portion in a direction different from a length direction of the base portion; and
an insertion portion that extends upward from the offset portion and is inserted in the insertion hole,
the bracket includes:
two first clamping portions that form a first holding hole for holding the support column and are configured to clamp the support column;
a first tightening portion that tightens the two first clamping portions;
two second clamping portions that form a second holding hole for holding the base portion and clamp the base portion; and
a second tightening portion that tightens the two second clamping portions, and
a central axis of the first holding hole extends along a central axis of the second holding hole.

12. The cymbal pad support structure according to claim 1, wherein the cymbal pad is an electronic cymbal pad including a vibration sensor configured to detect vibration of the cymbal pad.
